(19) United States
(12) Patent Application Publication
(10) Pub. No.: US 2024/0061906 A1
(43) Pub. Date: Feb. 22, 2024

(54) SYSTEM AND METHOD FOR DOWNSAMPLING DATA

(71) Applicant: Toyota Research Institute, Inc., Los Altos, CA (US)

(72) Inventor: Jens Strabo Hummelshøj, Brisbane, CA (US)

(73) Assignees: Toyota Research Institute, Inc., Los Altos, CA (US); Toyota Jidosha Kabushiki Kaisha, Toyota-shi (JP)

(21) Appl. No.: 17/888,810

(22) Filed: Aug. 16, 2022

(51) Int. Cl. G06K 9/62; G06N 20/00

(52) U.S. Cl. CPC G06K 9/6228; G06K 9/6298; G06N 20/00

(57) ABSTRACT

Systems, methods, and other embodiments described herein relate to downsampling training data so as to simplify the training of models as well as increase the prediction accuracy of the models. In one embodiment, a method includes training a model on a dataset to learn a covariance function, determining a covariance between a selected data value and the dataset using the covariance function, selecting a subset from the dataset based on the covariance, and predicting one or more potential experiments based on the subset.

### TECHNICAL FIELD

The subject matter described herein relates, in general, to systems and methods for downsampling training data.

### BACKGROUND

Machine learning models are useful in predicting outcomes based on the input information. The accuracy of these predictions is largely dependent on the quality of the training of the models, which may result from the amount and type of data the models use to train.

In addition to models improving prediction accuracy by training on large amounts of data, the models can further improve the prediction accuracy by training on data that has a relationship with the input information, such as common characteristics with the input information. Using training data that has a relationship with the input data may permit the models to train using less data, which may increase prediction accuracy and reduce training and processing time.

### SUMMARY

In one embodiment, a system for downsampling training data so as to simplify the training of models as well as increase the prediction accuracy of the models is disclosed. The system includes a processor and a memory in communication with the processor. The memory stores machine-readable instructions that, when executed by the processor, cause the processor to train a model on a dataset to learn a covariance function, determine a covariance between a selected data value and the dataset using the covariance function, select a subset from the dataset based on the covariance, and predict one or more potential experiments based on the subset.

In another embodiment, a method for downsampling training data so as to simplify the training of models as well as increase the prediction accuracy of the models is disclosed. The method includes training a model on a dataset to learn a covariance function, determining a covariance between a selected data value and the dataset using the covariance function, selecting a subset from the dataset based on the covariance, and predicting one or more potential experiments based on the subset.

In another embodiment, a non-transitory computer-readable medium for downsampling training data so as to simplify the training of models as well as increase the prediction accuracy of the models. The non-transitory computer-readable medium includes instructions that, when executed by a processor, cause the processor to perform one or more functions, is disclosed. The instructions include instructions to train a model on a dataset to learn a covariance function, determine a covariance between a selected data value and the dataset using the covariance function, select a subset from the dataset based on the covariance, and predict one or more potential experiments based on the subset.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a data flow of a data downsampling system.

FIG. 2 illustrates one embodiment of the data downsampling system.

FIG. 3 is a flowchart illustrating one embodiment of a method associated with downsampling data.

### DETAILED DESCRIPTION

Systems, methods, and other embodiments associated with systems and methods for downsampling training data are disclosed. Training a model on a large dataset of training data may be demanding on the training resources as the computational demands may increase as the size of the dataset increases. Additionally, the dataset may include training data that does not improve the prediction accuracy of the model. In such a case, portions of the training data may be irrelevant and have no or very low relationship with a prediction data point (also known as a selected data value), which is the data point that the system is predicting an outcome for.

It may be beneficial to train the model on a subset of the dataset so as not to overextend the computational resources being used during the training process since the computation would be carried out on a smaller dataset with fewer data points. The subset may include training data that has a relationship with the prediction data point. In some arrangements, a system generates the subset from the dataset by selecting data points in the dataset that have a relationship with the prediction data point. Training the model using training data that has a relationship, such as one or more common characteristics with the prediction data point, may increase the accuracy of predicting the outcome for the related prediction data point.

Current methods to predict an outcome for a prediction data point have included applying machine learning processes such as Kernel Principal Component Analysis (Kernel PCA) or Data Shapley method. However, these processes can be expensive and require extensive computational resources as the Kernel PCA and the Data Shapley method utilize the complete dataset and not a more tailored subset. Further, in addition to requiring a large amount of computational resources, these processes are unable to provide a more accurate outcome.

Accordingly, systems, methods, and other embodiments associated with downsampling training data are disclosed. The system can downsample training data so as to simplify the training of models as well as increase the prediction accuracy of the models. In other words, the system may select an optimal subset of a dataset to use as training data (X0, Y0) for prediction at (or proximate to) a data point (x1) with an unknown outcome (y1). The data point (x1) may be a single data point (x1, y1) or may be a representative data point for a set of data points (X1, Y1). The representative data point may be a cluster center of the set of data points (X1, Y1). The system may train a model such as a Gaussian Process model on all or a portion of the training data (X0, Y0) so the model learns a covariance function. The system then determines the covariance between the data point (x1) and the related components in the training data (X0). The system then selects the top N data points from the training data (X0, Y0) that have the highest covariance with the data point (x1). The value of N can be any suitable number, such as 100, such that the system selects the top 100 data points from the training data (X0, Y0). The system may form a subset with the top N data points and may use the subset to train a second model. As an example, the system may use the subset to train the second model, which is used to predict potential experiments.

Additionally and/or alternatively, the system may use the subset to further train the model. As another example, the system may use the subset to refit the covariance function.

As an example, the system may be used for closed loop discovery. In such an example, the system may be used for material discovery during experiments. The system may receive data outcomes from experiments that have been carried out and may combine the data outcomes with the training data. The system may then train a machine learning model using the training data. The system may use the machine learning model to determine the next set of experiments. The machine learning model may predict the outcome of the experiments and further determine the uncertainty associated with the prediction. A user may select the experiments to execute based on the predicted outcome and uncertainty.

Certain models are limited in the number of data points the models can process. As such, a system that can downsample a large dataset to a subset of the dataset that is more manageable for the models that are limited. Models may be parametric or non-parametric. As an example, the Gaussian Process model is non-parametric and may be limited by the number of data points the Gaussian Process model may process. In such an example, the system may downsample a large dataset of 1 billion data points to ten thousand data points, which is more manageable by the Gaussian Process model. As previously mentioned, the system selects the ten thousand data points based on the covariance between the one billion data points and a selected data value. The Gaussian Process model using a more relevant subset of the ten thousand data points enables the Gaussian Process model to be more accurate.

In one or more arrangements, the system may downsample training data by generating virtual data points and associating the training data in a dataset with one of the virtual data points. As an example, the dataset may include one million data points. In such an example, the system may generate one hundred virtual data points in the same space as the dataset. As an example, the system may ensure that the virtual data points have little to no relationship with each other by applying a covariance function to the virtual data points and selecting the virtual data points based on the low covariance between the virtual data points. Upon selecting the virtual data points, the system may then apply the covariance function between the one million data points and the one hundred virtual points to determine which of the one hundred virtual data points has the largest covariance with each of the one million data points. The system may associate each of the one million data points with a single virtual data point. As such, all the data points associated with the single virtual data point form a cluster and the virtual data point is the representative data point for the cluster. As such, the dataset is divided into one hundred clusters with one hundred representative data points.

The system may then develop a model for each of the one hundred clusters, resulting in one hundred models. In a case where the system receives a selected data value to predict an outcome for, the system may apply the covariance function to the selected data value and the representative data point for each of the clusters. The system then selects one of the one hundred models based on the representative data point that has the highest covariance with the selected data value. The system uses the selected model to predict an outcome and uncertainty for the selected data value.

The embodiments disclosed herein present various advantages over conventional technologies that predict an outcome based on a prediction data point. First, the embodiments can provide a more accurate prediction of the outcome for the prediction data point. Second, the embodiments are less resource-intensive than the prior art. Third, the embodiments simplify the process of predicting the outcome for the prediction data point.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

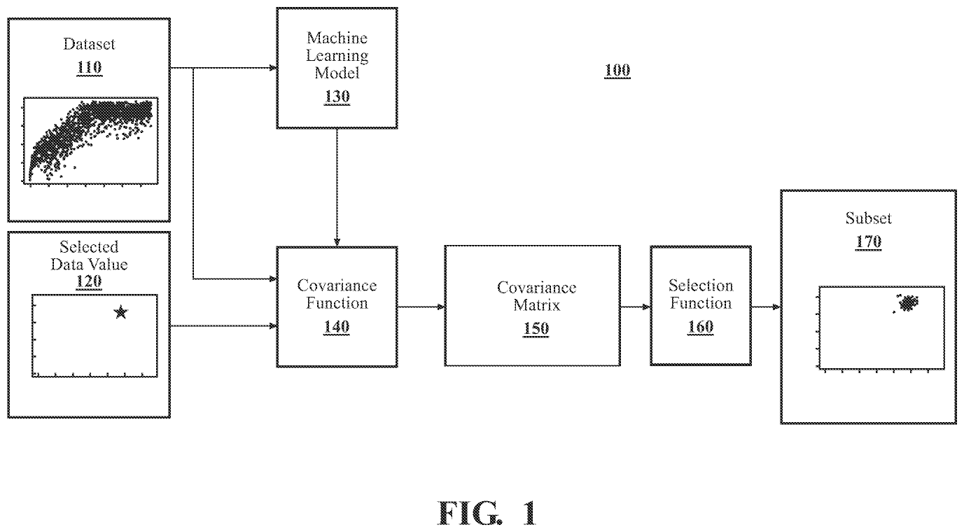

FIG. 1 illustrates a data flow of a data downsampling system 100. The data downsampling system 100 may include various elements, which may be communicatively linked in any suitable form. As an example, the elements may be connected, as shown in FIG. 1. Some of the possible elements of the data downsampling system 100 are shown in FIG. 1 and will now be described. It will be understood that it is not necessary for the data downsampling system 100 to have all the elements shown in FIG. 1 or described herein. The data downsampling system 100 may have any combination of the various elements shown in FIG. 1. Further, the data downsampling system 100 may have additional elements to those shown in FIG. 1. In some arrangements, the data downsampling system 100 may not include one or more of the elements shown in FIG. 1.

The data downsampling system 100 receives a dataset 110 and trains a model 130 using the dataset 110. The model 130 may be any suitable machine learning model. As an example, the model 130 may be a gaussian process model. The data downsampling system 100 receives the dataset 110. The dataset 110 may include a pair of data values, an input value and a related output value. The dataset 110 may be of any suitable size. As an example, the dataset 110 may have one million pairs of data values. The data downsampling system 100 may train the machine learning model 130 using the dataset 110 such that the machine learning model 130 may generate a covariance function 140. The covariance function 140 is an algorithm that can be applied to two data values to determine the covariance (or relationship) between the two data values.

The data downsampling system 100 receives a selected data value 120. As an example, the selected data value 120 may be a single data point. As another example, the selected data value 120 may be a cluster of data points. In other words, a group of data points. The data downsampling system 100 may apply the covariance function to the selected data value 120 and the dataset 110, particularly the input values within the dataset 110. As an alternative, the data downsampling system 100 may apply the covariance function 140 to the selected data value 120 and the input values of a portion of the dataset 110. The data downsampling system 100 may select the portion of the dataset 110 in any suitable manner. As an example, the data downsampling system 100 may select the portion of the dataset 110 in a random manner.

In response to applying the covariance function 140 to the selected data value 120 and the input values of the dataset 110, the data downsampling system 100 generates a covariance matrix 150 based on the covariance values between the selected data value 120 and the input values within the dataset 110. The data downsampling system 100 then selects pairs of data values from the dataset 110 using a selection function 160. The selection function 160 may be any suitable function such as selecting the top 100 pairs of data values with the highest covariance values or selecting the pairs of data values that have a covariance value that meets or exceeds a predetermined threshold value. The data downsampling system 100 can then use the top 100 pairs of data values to predict, as an example, future experiments.

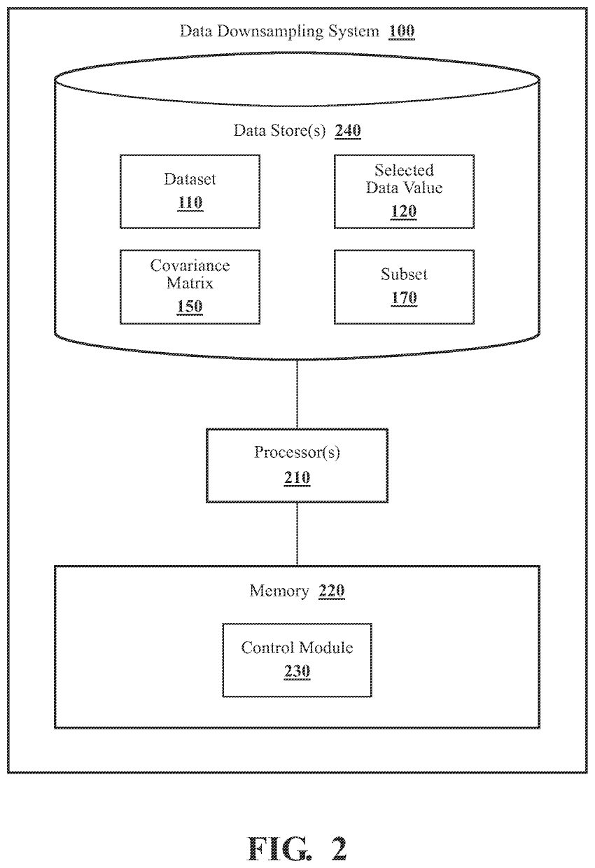

With reference to FIG. 2, one embodiment of the data downsampling system 100 of FIG. 1 is further illustrated. The data downsampling system 100 is shown as including a processor 210. Accordingly, the processor 210 may be a part of the data downsampling system 100, or the data downsampling system 100 may access the processor 210 through a data bus or another communication path. In one or more embodiments, the processor 210 is an application-specific integrated circuit (ASIC) that is configured to implement functions associated with a control module 230. In general, the processor 210 is an electronic processor, such as a microprocessor, that is capable of performing various functions as described herein.

In one embodiment, the data downsampling system 100 includes a memory 220 that stores the control module 230 and/or other modules that may function in support of downsampling data. The memory 220 is a random-access memory (RAM), read-only memory (ROM), a hard disk drive, a flash memory, or another suitable memory for storing the control module 230. The control module 230 is, for example, machine-readable instructions that, when executed by the processor 210, cause the processor 210 to perform the various functions disclosed herein. In further arrangements, the control module 230 is a logic, integrated circuit, or another device for performing the noted functions that includes the instructions integrated therein.

Furthermore, in one embodiment, the data downsampling system 100 includes a data store 240. The data store 240 is, in one arrangement, an electronic data structure stored in the memory 220 or another data store, and that is configured with routines that can be executed by the processor 210 for analyzing stored data, providing stored data, organizing stored data, and so on. Thus, in one embodiment, the data store 240 stores data used by the control module 230 in executing various functions.

For example, as depicted in FIG. 2, the data store 240 includes the dataset 110, the selected data value 120, the covariance matrix 150, and the subset 170, along with, for example, other information that is used and/or produced by the control module 230. The dataset 110 includes a large collection of training data. Each piece of training data is a pair of data points, an input data point and a corresponding output data point. As an example and in relation to an x-y axis, the input data point may be an x value and the output data point may be a y value. As another example, the input data point(s) may be input value(s) for an experiment and the output data point(s) may be the outcome(s) of the experiment and/or the certainty of the outcome(s). The dataset 110 can be sourced from past tests and/or experiments that have been conducted. The dataset 110 can be selected from a larger dataset using any suitable algorithm such as a random process.

As previously mentioned, the data downsampling system 100 can use the dataset 110 as training data for the machine learning model 130. The selected data value 120 is an input data value for which the data downsampling system 100 will predict an outcome. As an example, the selected data value 120 can be a single data point. As another example, the selected data value 120 can be a cluster of data points.

The covariance matrix 150 is a matrix of the covariance between the input data points of the dataset 110 and the selected data value 120. The subset 170 is a portion of the dataset 110. The subset 170 can include a selection of a certain number of input data points from the dataset 110. The selection can be of a certain number of input data points that have the largest covariance. As an example, the top 100 input data points with the largest covariance. As another example, the selection can be of input data points that have a covariance that meets or exceeds a predetermined threshold value.

While the data downsampling system 100 is illustrated as including the various data elements, it should be appreciated that one or more of the illustrated data elements may not be included within the data store 240 in various implementations and may be included in a data store that is external to the data downsampling system 100. In any case, the data downsampling system 100 stores various data elements in the data store 240 to support functions of the control module 230.

In one embodiment, the control module 230 includes instructions that, when executed by the processor(s) 210, cause the processor(s) 210 to train a model 130 on a dataset 110 to learn a covariance function 140, determine a covariance between the selected data value 120 and the dataset 110 using the covariance function 140, select a subset 170 of the dataset 110 based on the covariance, and predict one or more potential experiments based on the subset 170.

In one or more arrangements and as mentioned above, the control module 230 can train the model 130 on the dataset 110 to learn the covariance function 140. As an example, the control module 230 can feed the dataset 110 to the machine learning model 130 such that the machine learning model 130 learns the covariance function 140. The control module 230 can utilize any suitable algorithm to train the machine learning model 130.

In one or more arrangements and as mentioned above, the control module 230 can determine the covariance between the selected data value 120 and the dataset 110 using the covariance function 140. As an example, the control module 230 can apply the covariance function 140 to the selected data value 120 and the input data points of the dataset 110 to generate the covariance between the selected data value 120 and each of the input data points of the dataset 110. In the case where the selected data value 120 is a single data point, the control module 230 can apply the covariance function 140 to the single data point and the dataset 110 to generate the covariance.

In the case where the selected data value 120 is a cluster of data points, the control module 230 may select a single representative data point to represent the cluster of data points. The control module 230 may select the representative data point based on any suitable algorithm or process. As an example, the control module 230 may generate the representative data point based on averaging the values, coordinates, and/or parameters of the data points in the cluster. The representative data point may be one of the data points in the cluster. Alternatively, the representative data point may be a virtual data point generated by the control module 230. The control module 230 may apply the covariance function 140 to the representative data point and the dataset 110. As another example, the control module 230 may use multiple data points or all the data points within the cluster to determine the covariance between the cluster of data points and the dataset 110.

The control module 230 can apply the covariance function to the single data point and the dataset 110, the representative data point and the dataset 110, the multiple data points and the dataset 110, or all the data points in the cluster and dataset 110 so as to obtain the covariance. The control module 230 can then populate the covariance matrix 150 based on the covariance.

In one or more arrangements and as mentioned above, the control module 230 can select a subset 170 from the dataset 110 based on the covariance. As an example, the control module 230 can select the subset 170 based on the covariance being higher than a predetermined value. In other words, the control module 230 may select input data points that have a covariance with the selected data value 120 that is larger than the predetermined threshold value. As another example, the control module 230 may select a certain number of data points with the largest covariance. In such an example, the control module 230 may select the top 100 data points for the subset 170.

In one or more arrangements and as mentioned above, the control module 230 can predict one or more potential experiments based on the subset 170. As an example, the control module 230 can use the subset 170 as the training data for an experiment prediction model. In such an example, the control module 230 can determine the potential experiments based on the selected data value 120 and the experiment prediction model that was trained with the subset 170.

In one or more arrangements, the control module 230 may train the machine learning model 130 using the subset 170 as the training data. As an example, the subset 170 may be combined with the dataset 110. In such an example, the subset 170 and the dataset 110 may be weighted to different values. As another example, the control module 230 may use the subset 170 without the dataset 110 to train the machine learning model 130.

In one or more arrangements, the control module 230 may refit the covariance function 140 with the subset. Additionally and/or alternatively, the control module may use the subset to train a second machine learning model.

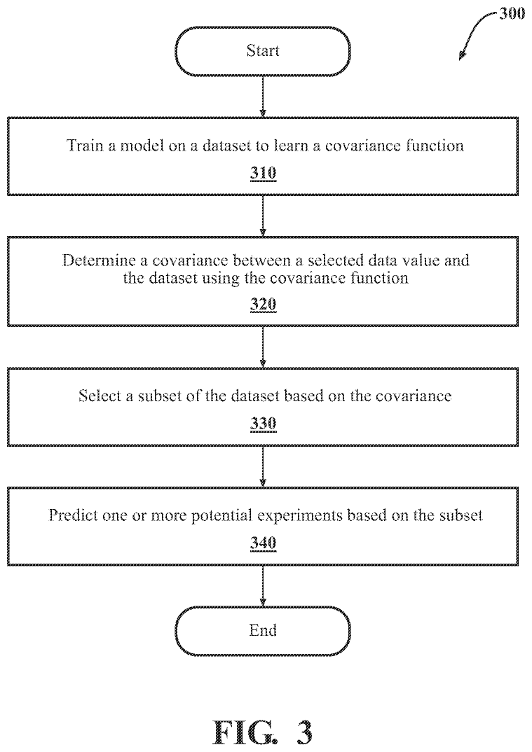

FIG. 3 is a flowchart illustrating one embodiment of a method 300 associated with downsampling data. The method 300 will be described from the viewpoint of the data downsampling system 100 of FIGS. 1-2. However, the method 300 may be adapted to be executed in any one of several different situations and not necessarily by the data downsampling system 100 of FIGS. 1-2.

At step 310, the control module 230 may cause the processor(s) 210 to train a model 130 on a dataset 110 to learn a covariance function 140. The control module 230 may select the dataset 110 from a larger dataset and/or data source. As previously mentioned, the control module 230 may train the model 130 using a dataset 110, a subset 170, or a combination of the dataset 110 and the subset 170. The control module 230 may train the model 130 using a gaussian process. The model may be a machine learning model.

At step 320, the control module 230 may cause the processor(s) 210 to determine a covariance between a selected data value 120 and the dataset 110 using the covariance function 140. As an example, the selected data value 120 can be a single data point. As another example, the selected data value 120 can be a cluster or group of data points.

At step 330, the control module 230 may cause the processor(s) 210 to select a subset 170 of the dataset 110 based on the covariance. As an example, the control module 230 may select the subset 170 based on covariance values that are equal to or higher than a predetermined threshold value.

At step 340, the control module 230 may cause the processor(s) 210 to predict one or more potential experiments based on the subset 170. As previously mentioned, the control module 230 may train the model 130 on the subset 170. Additionally and/or alternatively, the control module 230 may refit the covariance function 140 using the subset 170. As another example, the control module 230 may train a second (e.g., another) model using the subset 170.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3 but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
train a model on a dataset to learn a covariance function;
determine a covariance between a selected data value and the dataset using the covariance function;
select a subset of the dataset based on the covariance; and
predict one or more potential experiments based on the subset.

2. The system of claim 1, wherein the selected data value is at least one of a data point or a cluster of data points.

3. The system of claim 1, wherein the machine-readable instructions further include instructions that when executed by the processor cause the processor to:
select the subset based on the covariance being higher than a predetermined value.

4. The system of claim 1, wherein the machine-readable instructions further include instructions that when executed by the processor cause the processor to:
train the model on the subset.

5. The system of claim 1, wherein the machine-readable instructions further include instructions that when executed by the processor cause the processor to:
refit the covariance function with the subset.

6. The system of claim 1, wherein the machine-readable instructions further include instructions that when executed by the processor cause the processor to:
train a second model with the subset.

7. The system of claim 1, wherein the machine-readable instructions further include instructions that when executed by the processor cause the processor to:
select the dataset from a larger dataset in a random manner.

8. The system of claim 1, wherein the model is a Gaussian process model.

9. A method comprising:
training a model on a dataset to learn a covariance function;
determining a covariance between a selected data value and the dataset using the covariance function;
selecting a subset from the dataset based on the covariance; and
predicting one or more potential experiments based on the subset.

10. The method of claim 9, wherein the selected data value is at least one of a data point or a cluster of data points.

11. The method of claim 9, wherein the selecting the subset includes selecting the subset based on the covariance being higher than a predetermined value.

12. The method of claim 9, further comprising:
training the model on the subset.

13. The method of claim 9, further comprising:
refitting the covariance function with the subset.

14. The method of claim 9, further comprising:
training a second model with the subset.

15. The method of claim 9, further comprising:
selecting the dataset from a larger dataset in a random manner.

16. The method of claim 9, wherein the model is a Gaussian process model.

17. A non-transitory computer-readable medium including instructions that when executed by a processor cause the processor to:
train a model on a dataset to learn a covariance function;
determine a covariance between a selected data value and the dataset using the covariance function;
select a subset from the dataset based on the covariance; and
predict one or more potential experiments based on the subset.

18. The non-transitory computer-readable medium of claim 17, wherein the selected data value is at least one of a data point or a cluster of data points.

19. The non-transitory computer-readable medium of claim 17, wherein the instructions further include instructions that when executed by the processor cause the processor to select the subset based on the covariance being higher than a predetermined value.

20. The non-transitory computer-readable medium of claim 17, wherein the model is a Gaussian process model.
